(19) United States
(12) Patent Application Publication
(10) Pub. No.: US 2017/0313465 A1
(43) Pub. Date: Nov. 2, 2017

(54) PACKAGING BOX, TUBE, AND BLANK, AND METHOD AND APPARATUS FOR FORMING THE SAME

(71) Applicant: SCA Forest Products AB, Sundsvall (SE)

(72) Inventors: Magnus VISTRÖM, Sundsvall (SE); Rickard HÄGGLUND, Sundsvall (SE); Mattias BODELL, Sundsvall (SE)

(73) Assignee: SCA Forest Products AB, Sundsvall (SE)

(21) Appl. No.: 15/522,973

(22) PCT Filed: Oct. 31, 2014
(86) PCT No.: PCT/EP2014/073472

§ 371 Date: Apr. 28, 2017

(51) Int. Cl. B65D 5/36; B65D 5/42; B31B 50/07; B31B 50/00; B65D 5/468; B31B 50/78; B31B 2100/00; B31B 2110/20

(52) U.S. Cl. CPC B65D 5/3628; B65D 5/4608; B65D 5/4266; B31B 50/786; B31B 50/07; B31B 50/0014; B31B 2110/20; B31B 2100/0022

(57) ABSTRACT

A packaging box is disclosed, able to have smoothly curved wall portions. The box includes a perimeter wall defining a void thereby. The perimeter wall includes a first fold line and a second fold line. The first fold line and the second fold line may be parallel. A distance around the perimeter wall from the first fold line to the second fold line measured in a first plane perpendicular to the first and second fold lines in a first rotational sense is the same as a distance around the perimeter wall from the first fold line to the second fold line in the first plane in a second rotational sense opposite to the first rotational sense. When the first fold line is fully unfolded, the perimeter has a continuous surface including the first fold line. A tube, blank, method and machine for forming the box are also disclosed.

### CROSS-REFERENCE TO PRIOR APPLICATION

This application is a §371 National Stage Application of PCT International Application No. PCT/EP2014/073472 filed Oct. 31, 2014, which is incorporated herein in its entirety.

### TECHNICAL FIELD

The present disclosure relates to a packaging box, and particularly to a packaging box which is able to provide curved edge portions. The present disclosure also relates to a tube for forming the packaging box, a contiguous blank for forming the packaging box, a method for forming the tube into the packaging box, and an apparatus for forming the packaging box from the tube.

### BACKGROUND

Conventional packaging boxes, for example corrugated boxes or cardboard boxes, are typically in the form of a rectangular prism, sometimes termed “brick shape”, having six rectangular or square faces, respectively two pairs of side walls and each of a top and bottom wall, defining an internal void for containing the packaged articles. While such rectangular forms may be efficient from the point of view of saving space, design possibilities are limited with conventional packaging boxes. Curved forms can be particularly attractive to customers, and can convey an impression of greater quality or luxury as compared with rectangular forms.

Although some packaging boxes having curved portions are known to exist in the art, many of these are difficult or expensive to fabricate and thus require more complex production methods and correspondingly lower efficiency in their production. Also, when such curved packaging boxes are constructed, a generally thicker material is needed to ensure both stacking strength and rigidity, but cracks and kinks can easily appear when thicker material is forced into a curved shape. Curved packaging boxes of thinner material often are limited to specialist applications in which stacking strength is of relatively lesser importance.

Accordingly, there is a need for an improved packaging box having curved corners and edges. There is also a need for improved tubes and blanks from which the box can be formed, together with improved methods and apparatus for assembling the tubes and blanks into the box.

### SUMMARY

According to a first aspect, there is provided a packaging box. The packaging box includes a perimeter wall defining a void therein. The perimeter wall is provided with a first fold line and a second fold line. The first fold line and the second fold line are parallel. A distance around the perimeter wall from the first fold line to the second fold line measured in a first plane perpendicular to the first and second fold lines in a first rotational sense is the same as a distance around the perimeter wall from the first fold line to the second fold line in the first plane in a second rotational sense opposite to the first rotational sense. The first fold line is fully unfolded such that the perimeter wall has a continuous surface including the first fold line.

In one embodiment, the second fold line is fully unfolded such that the perimeter wall has a continuous surface including the second fold line.

In one embodiment, the box includes an internal wall portion arranged at an angle to the perimeter wall and to contact an internal surface of the perimeter wall so as to support the perimeter wall against an external compressive force directed toward the void.

In one embodiment, the internal wall portion is a base wall portion arranged in a plane.

In one embodiment, the internal wall portion is arranged in the first plane.

In one embodiment, the perimeter wall has at least a first curved portion that is smoothly curved in the first plane so as to include no fold line.

In one embodiment, the box has a plane of symmetry with respect to the shape of the perimeter wall within the first plane. The perimeter wall has a first end portion and a second end portion arranged at opposite positions. Each portion includes a respective one of first and second intersection positions with the plane of symmetry. At least one of the first and second end portions includes the curved portion. Optionally the second end portion includes a curved portion.

In one embodiment, the first end portion includes a pair of first curved portions of the perimeter wall. Each portion of the pair of first curved portions respectively extends in opposite senses from the first intersection position with the plane of symmetry toward a respective one of the first fold line and the second fold line.

In one embodiment, the first end portion includes a first planar portion of the perimeter wall including the first intersection position with the plane of symmetry arranged directly between the pair of first curved portions.

In one embodiment, a respective pair of third planar portions directly connects each portion of the pair of first curved portions to the respective one of the first fold line and the second fold line.

In one embodiment, the second end portion includes a pair of second curved portions of the perimeter wall, each portion of the pair of second curved portions respectively extending in opposite senses from the second intersection position with the plane of symmetry toward one of the first fold line and the second fold line.

In one embodiment, the second end portion includes a second planar portion of the perimeter wall including the second intersection position with the plane of symmetry arranged directly between the pair of second curved portions.

In one embodiment, a respective pair of fourth planar portions directly connects each portion of the pair of second curved portions to the respective one of the first fold line and the second fold line.

In one embodiment, the fourth planar portions are coplanar with the third planar portions across each fold line of the first fold line and the second fold line.

In one embodiment, the fourth planar portions are parallel to the third planar portions.

In one embodiment, the first fold line and the second fold line are positioned in the peripheral wall such that a distance across the void between the first fold line and the second fold line is a minimum distance with respect to position of the first fold line and the second fold line in the peripheral wall.

According to a second aspect, there is provided a tube for forming a packaging box. The tube includes a perimeter wall having a first layer and a second layer. The first layer and the second layer are mutually parallel and arranged for defining a void therebetween. The perimeter wall is provided with a first fold line and a second fold line. The first and second fold lines connect the first layer to the second layer at opposite ends of the first layer and the second layer. The first fold line and the second fold line are mutually parallel. A distance around the perimeter wall from the first fold line to the second fold line measured in a first plane perpendicular to the first and second fold lines in a first rotational sense is the same as a distance around the perimeter wall from the first fold line to the second fold line in the first plane in a second rotational sense. The perimeter wall is configured such that when the first layer and the second layer are relatively translated away from each other, the first fold line can be fully unfolded such that the perimeter wall has a continuous surface including the first fold line.

According to a third aspect, there is provided a contiguous blank for forming a packaging box. The blank includes a contiguous portion for defining the perimeter wall of the packaging box. The contiguous portion has a first portion and a second portion. The contiguous portion is provided with a first fold line connecting the first portion to the second portion at a first end of the first portion and a first end of the second portion. The contiguous portion has a second fold line connecting the first portion to a tab portion at the another end of the first portion. The first fold line and the second fold line are mutually parallel. The first fold line and the second fold line are both mutually parallel to another end of the first portion. A distance along the contiguous portion from the first fold line to the second fold line measured in a first direction perpendicular to the first and second fold lines is the same as a distance from the first fold line to the second end of the first portion.

According to a fourth aspect, there is provided an apparatus for forming a folded tube into a packaging box. The apparatus includes a handling means for transporting the folded tube to a first position at a forming station in which the folded tube in a flat state is arranged perpendicular to a machine direction. The handling means has a gripping means for gripping a planar portion of the peripheral wall. The handling means has a forming means having an insert portion for insertion in a first direction perpendicular to the machine direction between the one and the other of the first and second layers at the forming station. The insert portion has a front surface portion facing the machine direction for contacting a first one of the first and second layers. The insert portion has an insertion-direction edge in the insertion direction. The insert portion has a pair of curved surface portions extending outwardly in a second direction perpendicular to the machine direction and the first direction from opposite sides of the front surface portion. The curved surface portions curve away from the front surface portion in a direction opposite to the machine direction. The curved surface portions taper from the front surface portion such that the insertion-direction edges of the curved surface portions progress further in a direction opposite to the insertion direction of the insertion-direction edge of the front surface portion with distance away from the front surface portion in the second direction. The insertion means and the gripping means are relatively movable towards each other in the insertion direction. The insertion means and the gripping means are relatively movable in the machine direction away from each other.

According to a fifth aspect, there is provided a method of forming a tube into a packaging box. The method includes providing the tube in a folded configuration in which the first layer and the second layer are approximated such that the fold lines are fully folded. The method includes translating one of the layers apart from the other of the layers such that the fold lines each become relatively less folded. Thereby, the box is formed.

According to a sixth aspect, there is provided a packaging box. The packaging box includes a first pair of side wall portions. The first pair of side wall portions are arranged perpendicular to a first plane. The first pair of side wall portions mutually face. The first pair of side wall portions thereby define a void therebetween. The packaging box includes a second pair of side wall portions. The second pair of side wall portions are arranged perpendicular to the first plane. The second pair of side wall portions mutually face across the void. The packaging box includes four connecting wall portions. The four connecting wall portions are arranged perpendicular to the first plane. Each connecting wall portion of the four connecting wall portions connects respectively one wall of the first pair of walls and one wall of the second pair of walls. Thereby the void is enclosed. Each portion of the second pair of side wall portions has a fold line. Each fold line is at a position intermediate of the corner wall portions connected to the respective side wall portion.

In one embodiment, at least one, optionally two, and further optionally all, of the connecting wall portions are smoothly curved.

In one embodiment, the fold lines are perpendicular to the plane.

In one embodiment, the first pair of side wall portions are longer or shorter in the plane than the second pair of side wall portions.

In one embodiment, the second pair of side wall portions are each planar.

In one embodiment, the packaging box further includes a first base wall arranged in the first plane. The base wall includes a first base wall portion extending from one of the first pair of side wall portions. The base wall includes a second base wall portion extending from the other of the first pair of side wall portions.

In one embodiment, the packaging box further includes a second base wall arranged parallel to the first plane. The second base wall is displaced in a direction normal to the first plane from the first base wall. The second base wall includes a third base wall portion extending from one of the second pair of side walls. The second base wall includes a fourth base wall portion extending from the other of the second pair of side wall portions.

In one embodiment, each portion of the first and second base wall portions are shaped so as to correspond to the shape of the side wall portion in the first plane.

In one embodiment, the fold lines are configured to fold to have an apex of the fold outwardly of the void.

In one embodiment, at least the connecting wall portions, and optionally the entire packaging box, are made of a flexible crease-resistant material.

In one embodiment, the packaging box further includes a first top wall arranged parallel to the first plane. The first top wall includes a first top wall portion. The first top wall portion extends from one of the first pair of side wall portions. The first top wall includes a second top wall portion. The second top wall portion extends from the other of the first pair of side wall portions.

In one embodiment, the packaging box further includes a second top wall. The second top wall is arranged parallel to the first plane. The second top wall is displaced in a direction normal to the first plane from the first top wall. The second top wall includes a third top wall portion. The third top wall portion extends from one of the second pair of side wall portions. The packaging box also includes a fourth top wall portion. The fourth top wall portion extends from the other of the second pair of side wall portions.

In one embodiment, the fold line of each portion of the second pair of side wall portions is at equal distances from each other around the perimeter of the box, regardless of the direction around the perimeter.

In one embodiment, the fold line of each portion of the second pair of side wall portions is at a position equidistant of the connecting wall portions connected to the respective side wall portion.

According to a seventh aspect, there is provided a tube for forming a packaging box. The tube includes a first pair of side wall portions. Each side wall portion of the first pair of side wall portions is planar and parallel to the other. The tube includes a second pair of side wall portions. Each side wall portion of the second pair of side wall portions is folded along a fold line. Each side wall portion of the second pair of side wall portions is connected to each portion of the first pair of side wall portions at a first pair of opposite edges in a first planar direction of each portion of the first pair of side wall portions. The tube includes four connecting wall portions. The four connecting wall portions connect respectively one of the first pair of walls and one of the second pair of walls. Each side wall portion of the second pair of side wall portions has the fold line at a position intermediate of the connecting wall portions connected to the respective side wall portion.

In one embodiment, the tube further includes a first base wall portion. The first base wall portion extends in a second planar direction perpendicular to the first planar direction from one of the first pair of side wall portions. The tube further includes a second base wall portion. The second base wall portion extends in the second planar direction from the other of the first pair of side wall portions.

In one embodiment, the tube further includes a third base wall portion. The third base wall portion extends in the second planar direction from one of the second pair of side wall portions. The tube further includes a fourth base wall portion. The fourth base wall portion extends in the second planar direction from the other of the second pair of side wall portions.

In one embodiment, each portion of the first and second base wall portions have curved edges which curve away from the edges of the connecting wall portions.

In one embodiment, the fold lines are configured to fold to have an apex of the fold at an outer edge of the tube.

In one embodiment, the connecting wall portions are made of a flexible crease-resistant material.

In one embodiment, the tube further includes a first top wall portion. The first top wall portion extends in a third planar direction opposite to the second planar direction from one of the first pair of side wall portions. The tube further includes a second top wall portion extending in the third planar direction from the other of the first pair of side wall portions.

In one embodiment, the tube further includes a third top wall portion extending in the third planar direction from one of the second pair of side wall portions. The tube further includes a fourth top wall portion extending in the third planar direction from the other of the second pair of side wall portions.

In one embodiment, each fold line of the second pair of side wall portions is at a position equidistant of the connecting wall portions connected to the respective side wall portion.

According to an eighth aspect, there is provided a contiguous blank for forming a packaging item. The blank includes a first pair of side wall portions. Each side wall portion of the first pair of side wall portions is planar. The blank includes a second pair of side wall portions. Each portion of the second pair of side wall portions has a fold line about which the side wall portion may be folded. Each portion of the second pair of side wall portions is connected or connectable to each portion of the first pair of side wall portions at a first pair of opposite edges in a first planar direction of each portion of the first pair of side wall portions. The blank includes four connecting wall portions arranged for connecting respectively one of the first pair of side wall portions and one of the second pair of side wall portions. By folding each portion of the second pair of the side wall portions about its fold line and connecting each portion of the first pair of wall portions with a respective one of the second pair of wall portions via the connecting portions, the blank is foldable into a tube such that each portion of the second pair of side wall portions has the fold line at a position intermediate of the connecting wall portions connected to the respective side wall portion.

In one embodiment, the blank further includes a first base wall portion. The first base wall portion extends in a second planar direction perpendicular to the first planar direction from one of the first pair of side wall portions. The blank further includes a second base wall portion. The second base wall portion extends in the second planar direction from the other of the first pair of side wall portions.

In one embodiment, the blank further includes a third base wall portion. The third base wall portion extends in the second planar direction from one of the second pair of side wall portions. The blank further includes a fourth base wall portion. The fourth base wall portion extends in the second planar direction from the other of the second pair of side wall portions.

In one embodiment, each portion of the first and second base wall portions have curved edges. The curved edges curve away from the edges of the connecting wall portions.

In one embodiment, the connecting wall portions are made of a flexible crease-resistant material.

In one embodiment, the blank further includes a first top wall portion. The first top wall portion extends in a third planar direction opposite to the second planar direction from one of the first pair of side wall portions. The blank further includes a second top wall portion. The second top wall portion extends in the third planar direction from the other of the first pair of side wall portions.

In one embodiment, the blank further includes a third top wall portion. The third top wall portion extends in the third planar direction from one of the second pair of side wall portions. The blank further includes a fourth top wall portion. The fourth top wall portion extends in the third planar direction from the other of the second pair of side wall portions.

According to a ninth aspect, there is provided an apparatus for forming a folded tube into a packaging box. The apparatus includes a handling means for transporting the folded tube to a first position at a forming station. In the forming station, the folded tube in a flat state is arranged perpendicular to a machine direction. The handling means has a gripping means. The gripping means is for gripping one of the first pair of side wall portions. The handling means has a forming means. The forming means has an insert portion. The insert portion is for insertion in a first direction perpendicular to the machine direction between the one and the other of the first pair of side wall portions at the forming station. The insert portion has a front surface portion. The front surface portion faces the machine direction. The front surface portion is for contacting an inside of the one of the first pair of side wall portions. The insert portion has an insertion-direction edge in the insertion direction. The insert portion has a pair of curved surface portions. The curved surface portions extend outwardly in a second direction perpendicular to the machine direction and the first direction from opposite sides of the front surface portion. The curved surface portions curve away from the front surface portion in a direction opposite to the machine direction. The curved surface portions taper from the front surface portion such that the insertion-direction edges of the curved surface portions are progressively further in the insertion direction of the insertion-direction edge of the front surface portion with distance in the second direction. The insertion means and the gripping means are relatively movable towards each other in the insertion direction. The insertion means and the gripping means are relatively movable in the machine direction away from each other.

In one embodiment, the apparatus further includes a closing guide means. The closing guide means is arranged opposite to the insertion portion in the insertion direction. The closing guide means has a pair of curved surfaces defining a channel running parallel to the second direction for receiving the first and second base wall portions and for guiding the first and second base wall portions together to form a planar first base wall. The closing guide means and the insertion portion are relatively movable towards each other in the insertion direction. The closing guide means and the insertion portion are relatively movable in the machine direction away from each other.

In one embodiment, the apparatus further includes a pair of side closing means. The side closing means are arranged on opposite sides of the insert portion in the second direction. The side closing means are displaced from the insert portion in the insertion direction. The side closing means have closing surfaces which are movable in the second direction towards the insertion portion. The side closing means are for closing the third and fourth base wall portions to form a planar second base wall.

In one embodiment, the front surface of the insertion portion is planar.

In one embodiment, the gripping means includes a suction gripper.

In one embodiment, the apparatus includes a conveyor for transporting the box away from the forming station.

According to a tenth aspect, there is provided a method of forming a tube into a packaging box. The method includes providing the tube in a folded configuration in which a first pair of side walls are approximated and a second pair of side walls are folded along the fold lines. The method includes translating one of the first pair of side walls apart from the other of the second pair of side walls such that the second pair of side wall portions each become relatively less folded.

In one implementation, the method includes inserting an insert portion in an insertion direction perpendicular to the translation direction between the one and the other of the first pair of side wall portions.

In one implementation, the method further includes receiving first and second base wall portions in a channel. The channel is defined by a pair of curved surfaces formed in a guide means. The channel is arranged opposite to the insertion portion in the insertion direction. The channel runs parallel to the second direction. The method further includes guiding the first and second base wall portions together to form a planar first base wall by moving the guide means in a direction opposite to the insertion direction.

In one implementation, the method further includes closing third and fourth base wall portions to form a planar second base wall. The third and fourth base wall portions are closed to form a planar second base wall by moving, in the second direction towards the insertion portion, a pair of side closing means. The side closing means are arranged on opposite sides of the insert portion in the second direction. The side closing means are displaced from the insert portion in the insertion direction.

### BRIEF DESCRIPTION OF THE DRAWINGS

For a better understanding of embodiments of the present invention and to show how the same may be carried into effect, reference will be made, by way of example only, to the accompanying Drawings, in which:

FIG. 1 shows a packaging box;

FIG. 2 shows a packaging blank, and a process for folding the packaging blank into a tube, the packaging blank and the tube being suitable for forming the box of FIG. 1;

FIG. 3 shows an apparatus suitable for forming the box of FIG. 1 from the tube of FIG. 2;

FIGS. 4 to 10 show a sequence of steps in the operation of the machine of FIG. 3 for transforming the tube of FIG. 2 into the box of FIG. 1;

FIG. 11 shows a first alternative design for a packaging box;

FIG. 12 shows a second alternative design for a packaging box;

FIG. 13 shows a third alternative design for a packaging box;

FIG. 14 shows a fourth alternative design for a packaging box;

FIG. 15 shows a fifth alternative design for a packaging box; and

FIG. 16 shows a sixth alternative design for a packaging box.

### DETAILED DESCRIPTION OF PARTICULAR EMBODIMENTS

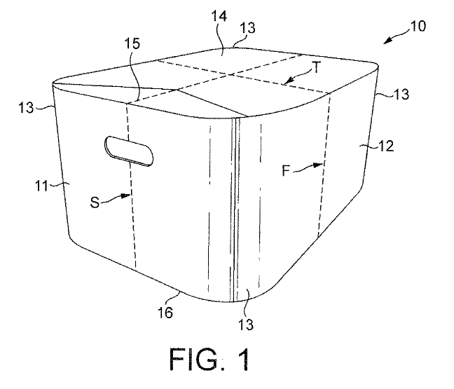

FIG. 1 shows a packaging box 10. Box 10 is formed from a single piece of sheet material, folded along predefined lines to define the box 10 enclosing a void suitable for storing objects therein.

Box 10 has a first pair of side wall portions 11 which are arranged perpendicular to a first plane and which face each other across the void. The first plane thus defines a plane on which the box may rest in use, and with reference to which the remainder of the box will be described.

The box also has a second pair of side wall portions 12, which are arranged perpendicular to the first plane and mutually facing across the void and, in the embodiment of FIG. 1, are also arranged perpendicular to the first pair of side wall portions. The box shown in FIG. 1 thus defined is broadly rectangular in plan and symmetric about a pair of perpendicular axes in the first plane which are perpendicular to the first and second pair of side wall portions.

However, without limitation, modification examples can be straightforwardly achieved wherein the box is not symmetric about the mentioned axes, the first and second pair of side wall portions are not, respectively, mutually perpendicular and the packaging box may then have a parallelepiped structure. The configuration shown is presently preferred for robustness and ease of stacking.

Connecting each of the first pair of side wall portions 11 and each of the second pair of side wall portions 12 are connecting wall portions 13 which are also arranged perpendicular to the first plane. As may be seen in FIG. 1, in the depicted configuration these portions have a smoothly curved form, curving from the planar surfaces of the first pair of side wall portions 11 to the planar surfaces of the second pair of side wall portions 12 without creases, folds or sharp changes in angle. By providing such curved connecting wall portions 13, the structure is strengthened, since a curved surface is generally more resistant to vertical compressive loading than an angled surface.

To achieve such a curve, a variety of materials may be selected to form the box. For example, as the skilled reader will appreciate, a variety of plastic sheet materials may be smoothly bent into a curved form to achieve the configuration as shown in FIG. 1. Smoothly bent, here, should be interpreted to mean bent into a continuously curved form, without cracks or kinks. Other paper materials, such as cardboard, can also be contemplated, provided that the radius of curvature of the curved potions is not so small as to cause creasing, kinking or folding. However, carton board has rather low bending stiffness, resulting in a low stacking strength, and if the thickness of the cartoon board material is increased in order to get a somewhat higher bending stiffness to enhance stacking strength, the ability of the material to bend without crease or kink formation will be limited, and small radius curves may not be achievable. Straightforward experimentation will allow the skilled person to select thicknesses and compositions of a wide variety of materials which may be appropriately curved and which may fulfil other engineering requirements for the packaging box. However, in a particular embodiment, the material for forming the box of FIG. 1 is the bendable board disclosed in the co-pending international application published as WO 2013/012362 A1, which is a flexible yet crease-resistant material, and which allows even small-radius corners to be obtained reliably and without creasing or kinks. Such a bendable board has in one configuration a middle layer, a first outer layer attached to the middle layer and a second outer layer attached to the middle layer. The middle layer may be corrugated, and the second outer layer may have a lower bending stiffness according to ISO 5628 than the first outer layer. The bendable board may therefore be outwardly bendable only in a direction towards which the second layer faces.

To fully enclose the void so that an object placed in box 10 may be securely retained, the embodiment of FIG. 1 also has planar base wall and top wall portions 14 and 16. Each of planar base wall portion 16 and top wall portion 14 is formed as a substantial double-layer of material achieved by folding inwardly respective top wall portions and base wall portions extending from opposed top and base edges of each of the first and second pair of side wall portions 11, 12.

In particular embodiments, at the edges where the top wall portions and base wall portions join the side wall portions, a living hinge or fold line is provided to allow a sharp edge to be obtained between the side walls and the top and base walls. This can facilitate stacking of the boxes and secure retention of their contents.

In the embodiment of FIG. 1, all of the connecting wall portions are smoothly curved. Alternatively, only one, two or three of the connecting wall portions may be smoothly curved, the non-curved portions being formed as angled edges in the conventional manner by providing suitable fold lines. However, for achieving the most improved stacking strength, all four connecting wall portions 13 can be smoothly curved.

In the embodiment of FIG. 1, the first pair of side wall portions 11 are shorter in the first plane than the second pair of side wall portions 12. However, this configuration can be reversed, and the first pair of side wall portions may be longer in the first plane than the second pair of side wall portions, according to preference. The first and second pair of side wall portions can also be equally long, as may be desired.

The embodiment of FIG. 1 has both a base wall portion 16 and a top wall portion 14, but only one of these wall portions may be present, for example, if it is desired to create an open-top box or a box cover for items already positioned on a tray. Further, both top wall portion 14 and base wall portion 16 may be absent if it is simply desired to provide a smoothly curved rectangular box sleeve to surround one or more objects, for example, for presentation or bundling purposes. Covers for the top and bottom of the box can alternatively be provided after the box is formed, for example by placing rigid inserts into the apertures formed at the top and base, or by attaching covering material to the top or base edges of the side wall portions.

In the embodiment of FIG. 1, the top wall 14 and base wall 16 have a peripheral shape at the edge adjoining the connecting wall portions 13 so as to correspond to the curve of connecting wall portions 13. This configuration provides inner support for the curve of connecting wall portions 13 and also provides a void which is uniformly enclosed and has no undesirable overhanging top or base portions. However, the top wall and base wall can, by appropriate choice of dimensions, be constructed so as to be smaller than a footprint of the box 10 in the first plane at either a top or base position, as may be preferred, if overhangs at the corners or small gaps at the corners may be acceptable or even desired. Such may, for example, facilitate stable stacking in the case of overhangs or allow air to circulate for e.g. efficient refrigeration or freezing in the case of small gaps.

To enable the box of FIG. 1 to be easily formed from a tube, each of the second pair of wall portions 12 has a fold line F running from top to base perpendicular to the first plane and allowing the second pair of wall portions to fold outwardly as the first pair of side wall portions are relatively approximated. In the configuration as shown in FIG. 1, the first pair of side wall portions 11 are sufficiently far spaced from each other that each of the side wall portions are planar and the fold line is completely unfolded. The portions of top wall 14 and base wall 16 extending from the second pair of side wall portions 12 have a corresponding fold line which is also correspondingly unfolded in the configuration of FIG. 1. However, these top wall portions and base wall portions could alternatively be provided with slits, in place of the fold lines, extending from the respective top or base edge of the second pair of side wall portions 12 to allow each of the second pair of side wall portions to be easily folded. Use of fold lines rather than slits in the top wall portions and/or base wall portions inhibits folding of the side wall portions along the fold line after the box has been formed and the angle between the side wall portion and the top wall or base wall is approximately a right angle. This arises because refolding the side wall portions, for example by applying a force from the side, would require also to fold the respective top wall or base wall portion with a force from above or below the box.

By providing such a fold line, the packaging box 10 may be expanded from or collapsed to a planar tubular form, in which the first pair of side wall portions 11 are fully approximated to contact each other on inner faces, the second pair of side wall portions 12 are folded about their respective fold lines to provide an outward-facing apex and are displaced outwardly from their locations as shown in FIG. 1, and the corner wall portions 13 are straight so as to form a contiguous plane from each of the first pair of side wall portions to each of the second pair of side wall portions, respectively. Such a feature allows the packaging box to be conveniently assembled from a flat form, and also to be conveniently collapsed for re-use, without subjecting the corner wall portions to undesired forces which may otherwise damage the smoothly curved form of the corners of the box.

The box shown in FIG. 1 thus has a number of features which may be applied generally to achieve desired configurations. Some of these now follow, while others will be apparent to the skilled reader by considering the forgoing disclosure.

As may be seen from FIG. 1, the first pair of side wall portions 11, the second pair of side wall portions 12 and the connecting wall portions 13 together define a perimeter wall surrounding, enclosing and defining the void, at least in two perpendicular dimensions. Here the fold lines F of the second pair of wall portions may be regarded as first and second fold lines. The first and second fold lines are mutually parallel, and a distance around the perimeter wall from the first fold line to the second fold line measured in the first plane perpendicular to the first and second fold lines in a first rotational sense, for example clockwise, is the same as a distance around the perimeter wall from the first fold line to the second fold line in the first plane in a second, opposite rotational sense, for example anticlockwise. These features allow the depicted box to be collapsed by folding at the first and second fold lines to a planar configuration. Further, by performing this operation in reverse, unfolding the first and second fold lines such that the perimeter wall has continuous surfaces each including the first fold line and the second fold line, the box having the curved portions may be obtained. Here, a continuous surface is a single surface without having abrupt changes in tangential direction or distinct faces, such that the surface is either flat or smoothly curved.

As may also be seen from FIG. 1, the base wall portion 14 and the top wall portion 16 each define an internal wall portion which contacts an internal surface of the perimeter wall so as to support the perimeter wall against an external compressive force directed toward the void. Such a configuration can assist in forming and maintaining the shape of the peripheral wall, and especially any smoothly curved portions or portions having fold lines. In the embodiment of FIG. 1, the internal wall portion is arranged to be perpendicular to the base or top wall, that is, perpendicular to the first plane, but such a wall could also be provided at an incline to the first plane.

Also as may be seen from FIG. 1, the packaging box has a plane of reflection symmetry S with respect to the shape of the perimeter wall within the first plane. With reference to this plane of symmetry, the perimeter wall can be thought of as having a first end portion and a second end portion arranged at opposite positions each including a respective one of first and second intersection lines of the peripheral wall with the plane of symmetry. Here, the first and second end portions include a respective one of the first pair of side wall portions as well as the curved connecting portions extending from that first side wall portion. Considering the connecting portions, each of the connecting portions then extends as part of the end portion, respectively in opposite rotational senses, along the peripheral wall away from the respective intersection portion with the plane of symmetry toward one of the first and second fold lines. Such a symmetric configuration can be easily arranged when packing several such boxes in a single layer beside each other. However, such a symmetric configuration is by no means essential, and asymmetric configurations can also be provided as desired.

Further, as may be seen from FIG. 1, the first end portion and a second end portion each have planar portions connecting the respective curved connecting portions and including the respective intersection line with the plane of symmetry. From the symmetry, the planar portions are parallel. The planar portions are here the respective parts of the second pair of side wall portions between the fold lines and the curved connecting portions. Such planar portions may similarly facilitate packing several of the boxes in a layer.

Next, as may be seen from FIG. 1, the second side wall portions are each planar, with the included fold line of each side wall portion being fully unfolded, that is, by 180 degrees from the fully folded configuration, so as to form a continuous, planar surface. Such continuous, planar surfaces may facilitate packing several of the boxes in a layer.

Additionally, as may be seen from FIG. 1, the second side wall portions are parallel. Such parallel surfaces can further assist in packing several of the boxes in a layer.

Next, it can be understood that, depending on the number of side walls and relative angles one to another of such walls, the smoothly curved potions need not curve through 90 degrees, as exemplified in the box of FIG. 1, but can curve through other angles. In some configurations, it may be desired that the curved portions curve through at least 15 degrees, optionally at least 30 degrees, further optionally at least 45 degrees. Curvature can be around a single centre of curvature, with a constant radius of curvature, or can exhibit smoothly varying curvature around a number of centres of curvature associated with different radii of curvature.

Finally, it can be seen that the box of FIG. 1 is symmetric by reflection with reference to a second plane T crossing the first plane of symmetry S at right angles and at right angles to the first plane. The distance across the void between the first fold line and the second fold line is a minimum, such that the shorter distance around the peripheral wall from the first fold line to one of the first and second intersection lines of the first plane of symmetry is the same as the shorter distance around the peripheral wall from the second fold line to the same one of the first and second intersection lines. The first fold line and the second fold line are thus positioned in the peripheral wall so as to lie within with the second plane of symmetry. Such a configuration, when folded, provides a particularly compact configuration.

Various other variant configurations embodying some or all of these concepts are disclosed in FIGS. 11 to 16. These variant configurations are presented such that the skilled reader may appreciate how the configuration of FIG. 1 may be adapted while retaining certain desirable properties.

FIG. 11 shows a cylindrical box. While the box may have a top or base wall, or may be sealed by a separate inserted plug, FIG. 11 only shows the configuration of the perimeter wall W of the box which defines the enclosed void. The box has two fold lines F diametrically opposed across the perimeter wall and connected by smoothly curved sections C of bendable material. By translating the fold lines F apart from one another, the bendable material adopts a planar configuration and the box can be collapsed. By the reverse operation, the cylindrical box can be formed from a planar tube. In FIG. 11, the fold lines F are parallel to each other, but need not be parallel to the entirety of the curved perimeter wall W. In other words, for this configuration, the fold lines F need not be parallel to the axis of the cylinder, but could be inclined to that axis.

FIG. 12 shows a modified form of the box of FIG. 11. The box of FIG. 12 has a perimeter wall W with semi-circular end portions E arranged at each end of a long axis, which is also contained in the plane of symmetry, but also has planar portions P connecting the end portions E and containing the fold lines F. The planar portions P may be made of the same bendable material as the end portions E, but may also be made of a material which is relatively stiffer and thus more resistant to bending and providing higher stacking strength.

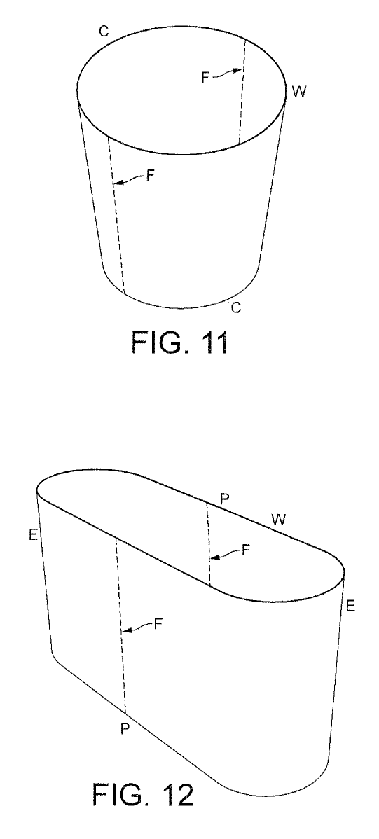

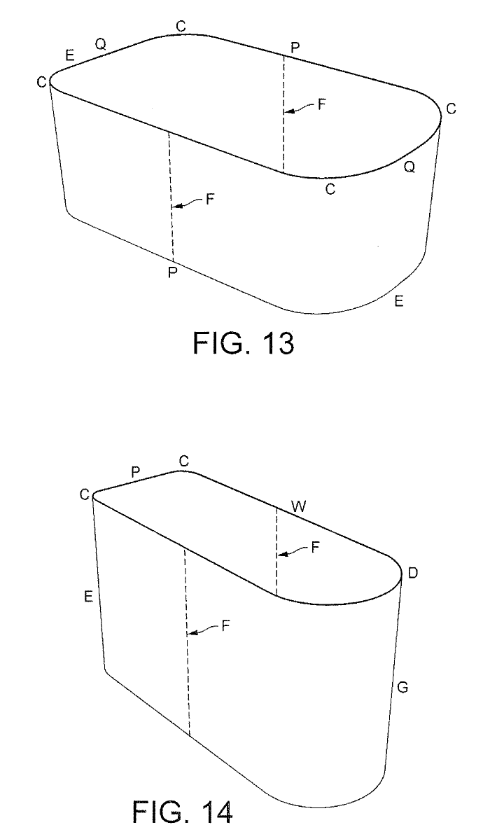

FIG. 13 shows a modified form of the box of FIG. 12, in which the perimeter wall W has further planar portions Q included in each end portion E, arranged between quarter-circle curved portions C. Similarly to the configuration of FIG. 12, the planar portions Q may be made of the same bendable material as the curved portions C, but may also be made of a material which is relatively stiffer and thus more resistant to bending.

FIG. 14 shows a hybrid design between the designs of FIGS. 12 and 13. The design of FIG. 14 has a perimeter wall W with one end portion E including a planar portion P and quarter-circle curved portions C and one end section G including a semi-circular portion D. The semi-circular portion D and the quarter-circular portion C thus need not have the same radius of curvature, but rather the quarter-circular portion C has a smaller radius of curvature than the circular portion D.

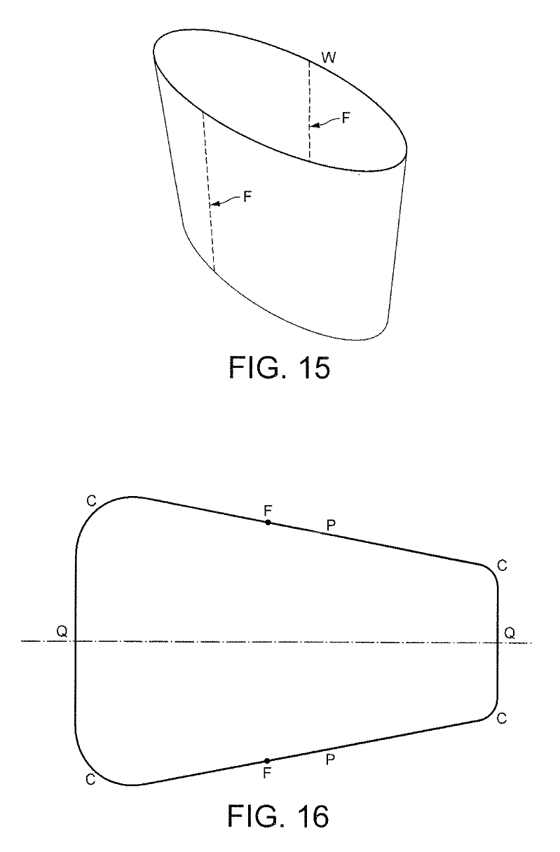

FIG. 15 shows a variant of the design of FIG. 12 in which the fold lines F are themselves included in an essentially continuous curved portion of the perimeter wall W, rather than a planar portion. No facet or substantial discontinuity in the perimeter wall W exists at the fold lines F or elsewhere. The perimeter wall W thus does not have defined part-circular and planar portions, but rather adopts a smoothly-curved form, the curvature of which varies with position around the perimeter wall. This configuration can be achieved by the use of appropriately-shaped end-plugs or top and base walls, or by configuring the perimeter wall W such that the flexibility varies with position around the perimeter. One process for achieving such an effect is to form the perimeter wall W such that the bending properties, including bending stiffness, of the perimeter wall is varied to provide a varying flexibility. For example, the thickness of the perimeter wall may be formed as thinner at the smaller-radius portions and thicker at the larger-radius portions. By providing a flattened two-layer tube having identical layers of perimeter wall material with suitably varying thickness and connected by fold lines at appropriate locations, and then by approximating the fold lines F until the perimeter wall material smoothly and continuously extends across the fold lines at the fold lines, the form shown in FIG. 15 may be achieved in a single operation. The configuration can then be maintained either by inhibiting the tendency of the perimeter wall to fold at the fold lines, for example by laminating the perimeter wall along the fold lines with adhesive tape, or by supporting the perimeter wall from the inside, for example by a base wall, top wall or plug.

FIG. 16 shows a plan view of a variant of the design of FIG. 13 in which the planar side walls P including the fold lines F are non-parallel, by way of contrast.

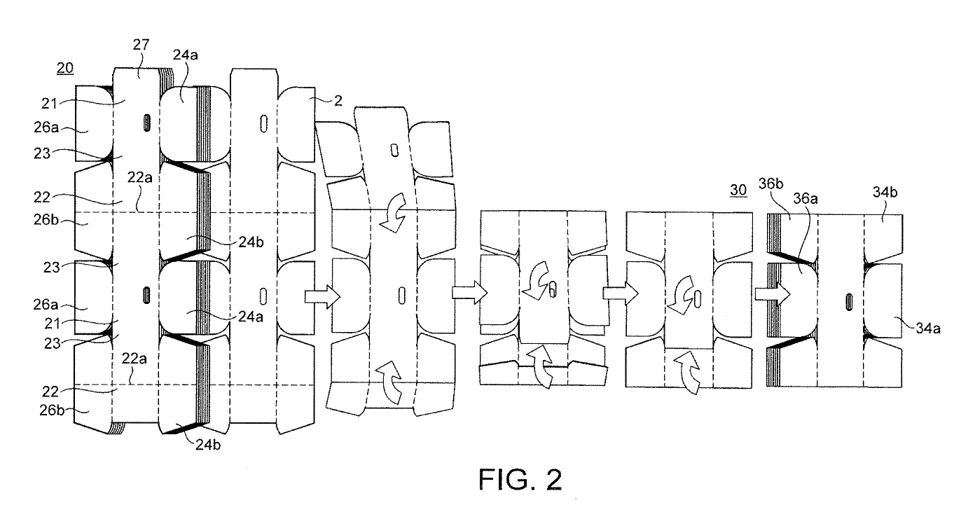

FIG. 2 shows in detail the process of forming, from a flat planar blank 20, a tube 30, from which the box of FIG. 1 may be formed. Planar blank 20 may be cut or stamped out of a single sheet of material. Alternatively, the planar blank may be formed by joining several portions of planar material together, for example by means of adhesive tabs, staples or stitches. In FIG. 2, elements of the blank 20 having reference numerals of the form 2x, and elements of the tube 30 having reference numerals of the form 3x, correspond mutually to elements of FIG. 1 having reference numerals of the form 1x.

As shown in FIG. 2, blank 20 has a first pair of side wall portions 21 and a second pair of side wall portions 22 arranged alternately in a line along the length of the blank 20 and having one of connecting wall portions 23 interposed at each position between one of the first pair of side wall portions and one of the second pair of side wall portions. In the configuration of FIG. 2, the sequence of side wall portions begins with one of the first pair of side wall portions 21 and ends with a connecting wall portion 22, although alternative permutations of this sequence are possible. From each one of the first pair of side wall portions 21, that is, in the width direction of the blank 20, a top wall portion 24a and a base wall portion 26a extend from respective opposite edges of the side wall portions not arranged next to connecting wall portions 23, while from each of the second pair of side wall portions 22, a top wall portion 24b and a base wall portion 26b extends. Between each of top wall portions 24a and bottom wall portions 26a and first side wall portions 21, and between each of top wall portion 24b and base wall portion 26b and respective side wall portions 22, fold lines are provided to act as a living hinge, about which the respective wall portions may be mutually folded.

In contrast, the entire sequence of side wall portions 21, 22 and interposed connecting wall portions 23 running the length of packaging blank 20 has no fold lines between the respective side wall portions 21, 22 and connecting portions 23. However, in each of the second pair of side wall portions 22, a fold line 22a is provided, running across the width of packaging blank 20, to enable each of the second pair of side wall portions to be folded almost 180 degrees about the fold line. The fold lines may extend from the side wall portions 22 along the top and base wall portions 24b and 26b, or a cut may be formed in these portions as an extension of the fold line to accommodate the folding and unfolding of these portions also. Generally, at one end of the sequence of side wall portions 21, 22 and connecting wall portions 23, which are arranged along the length direction, an extension portion 27 is provided as a tab to enable easy securing of one end of the sequence of side wall portions and connecting wall portions to the other end of the sequence when forming blank 20 into tube 30.

Referring again to blank 20, each of the top wall portions 24a and 24b and base wall portions 26a and 26b have curved edges facing the top and base edges of the connection wall portions 23 which curve away from the opposing edges of the connecting wall portions. By appropriately choosing the radius of these curved portions, the top wall 14 and base wall 16 shown in FIG. 1 constitute a template for the connecting wall portion 23 and, if the dimensions are appropriately selected, can be made to smoothly follow the form of the curved wall portion 13 when the blank is folded into the box 10.

The blank 20 is folded into tube 30 by folding along fold lines 22a as shown in the sequence of steps in FIG. 2. By folding the blank 20 inwardly along each fold line, such that extension portion 27 overlies the end of the sequence of side wall portions and connecting wall portions, a tubular construction can be formed being open at each end but being capable of being flattened to form an essentially planar structure having a double thickness of material as compared with blank 20. Extension portion 27 may be secured to the other end of the sequence of side wall portions and end wall portions by any suitably conventional means such as gluing, stapling or stitching.

In the tube 30, each of the connecting wall portions connecting each of the side wall portions is flat and in the same plane as the respective side wall portions adjoining it. This allows undesired creasing or folding to be prevented while the tube is being transported or stored.

Tube 30 may be easily transformed into box 10 by pulling apart the first pair of side wall portions 31 and appropriately folding in the base wall portions 36a and 36b and top wall portions 34a and 34b by hand.

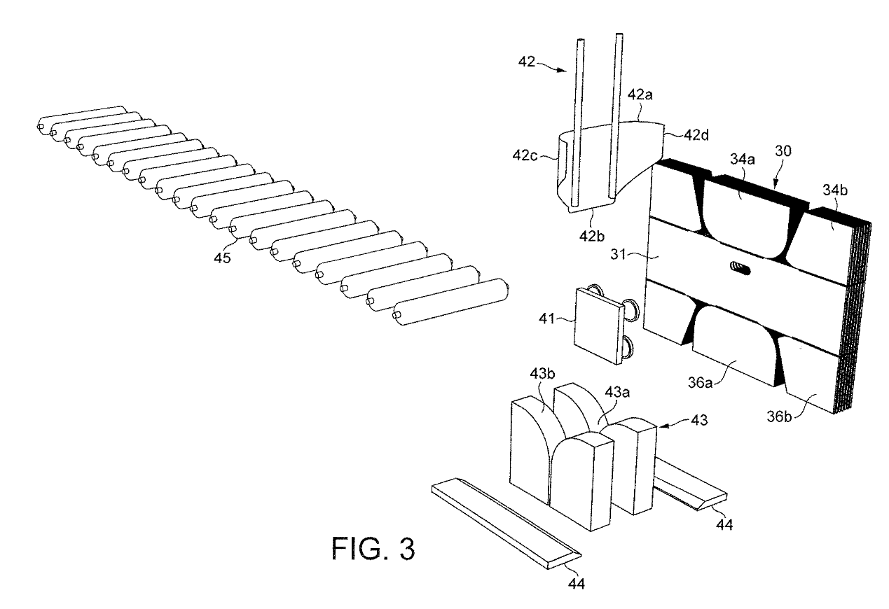

However, to most easily and efficiently form the boxes in an automated or semi-automated fashion, an apparatus for forming the box 10 of FIG. 1 from the blank 30 of FIG. 2 will now be explained, with reference to FIG. 3.

The apparatus of FIG. 3 has a suction device 41 having one or more suction cups which are able to grip one of the first pair of side wall portions 31 of tube 30, which is stored at a storage position in a storage area of the apparatus. Suction device 41 is able to move between the storage position and an unfolding position of the apparatus by, for example, providing suction device 41 on the end of a robot arm, not shown, which functions as a handling means. Other configurations aside from the combination of suction device and robot arm are possible, as may occur to the skilled person from the usual experience in automated handling systems. However, the suction device 41 of FIG. 3 is beneficial in terms of ease of use, responsiveness, and gentle handling of the material from which the tube 30 is made.

The apparatus of FIG. 3 also has a separation device at a forming position of the apparatus, for gently forming the tube 30 into box 10. The separation device has an insert portion 42 to be inserted between the first pair of side wall portions with the tube in a folded state, thereby to separate the side wall portions. The insert portion has a front surface portion 42a having a lower insertion-direction edge 42b and curved side portions 42c and 42d extending from either side of front surface portion 42a. The insert portion 42 thus has a generally spade-shaped configuration, with side wall portions 42c and 42d curving backwardly from the front surface portion. Furthermore, in the shown configuration, curved surface portion 42c and 42d are tapered as they extend backwardly, such that the profile of the curved surface portions narrows as the portions extend rearwardly relative to the front surface portion, and the insertion-direction edge of the curved surface portions 42c, 42d thereby sweep away from the insertion direction.

Edge portion 42b may be formed as a blade or wedge for easy insertion between the first pair of side wall portions of the tube.

Apparatus 40 also includes flap guides 43 located below the folding position, to accommodate base surface wall portions 36a when the tube is located at the forming position. Flap guides 43 have curved surfaces 43b which define a groove 43a running parallel to the front surface portion 42a of the insert portion 42. While FIG. 3 shows two flap guides 43 each having corresponding curved surfaces 43a and corresponding grooves 43a, a single flap guide may be provided, having a single channel, or a plurality thereof, without limitation. The flap guides 43 function to smoothly guide base wall portions 36a upwardly to form a first layer of base wall 16 of box 10 as the side wall portions 21 are relatively moved apart.

Apparatus 40 also includes flap closing rails 44, arranged either side of flap guides 43 for closing base surface wall portions 36a inwardly to form double-layer base wall 16 of box 10.

Conveyor 45 is provided to transfer box 10 from the forming position after formation.

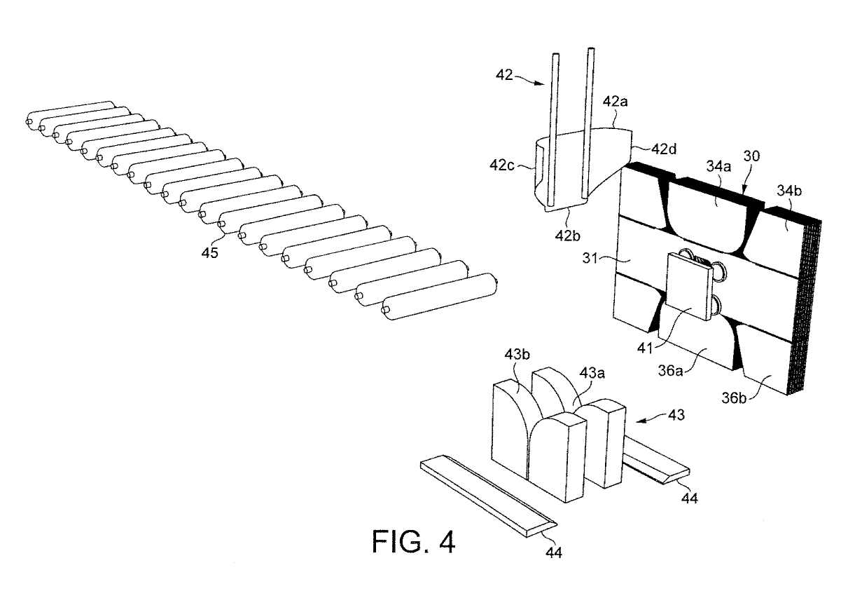

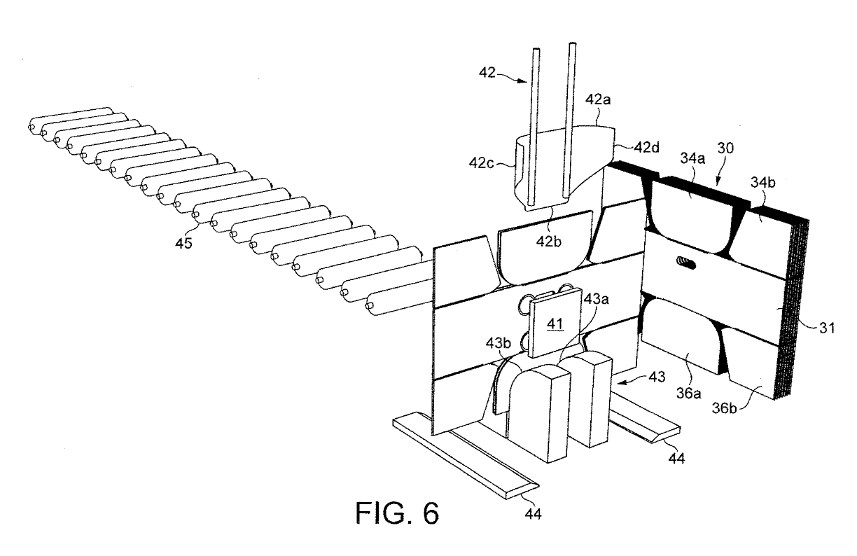

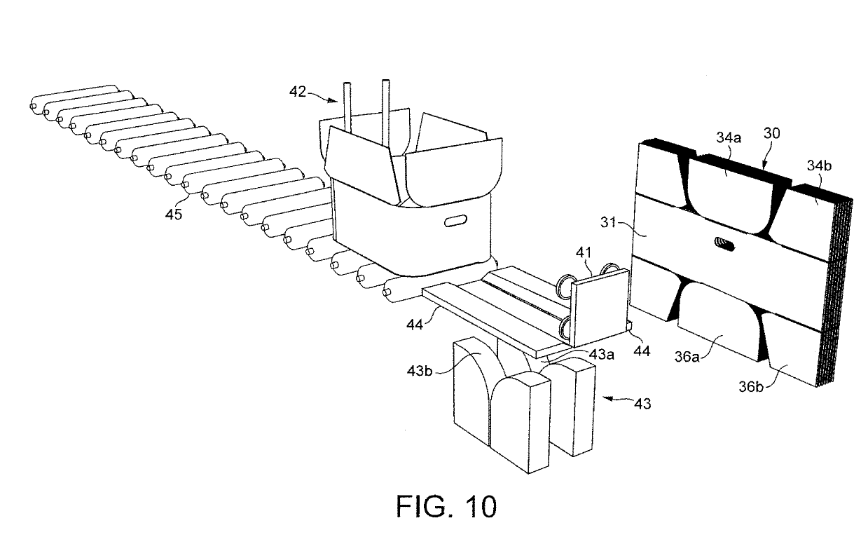

The operation of the apparatus shown in FIG. 3 will now be described with reference to FIGS. 4 to 10, which describe one implementation of the process for forming a box 10 as shown in FIG. 1 from a tube 30 as shown in FIG. 2.

In FIG. 4, the machine is in its starting position. Suction device 41 is gripping one of the first pair of side wall portions of tube 30, at a loading position, while the insertion portion 42 is retracted above the forming position and the flap guides 43 are located below the forming position. The flap closing rails 44 are lowered.

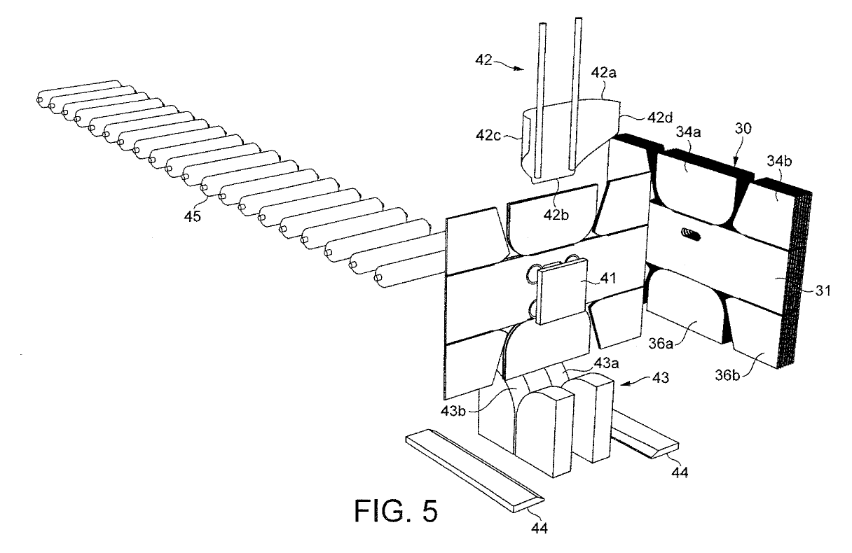

From this position, the suction device rotates the box 90 degrees in the horizontal plane and arranges the first pair of side wall portions, still in the approximated state, directly over the groove 43a formed in the flap guides 43. Edge portion 42b of the insert portion 42a is at this step located directly above the approximated first pair of side wall portions, such that a movement of the edge portion 42b in a downward direction causes the edge portion to travel between the first pair of side wall portions. This configuration is shown in FIG. 5.

Next, the flap guides 43 are raised so that the base wall portions 36a lie in the channel 43a defined by the curved surface 43b of the flap guides 43. It is important to note that the suction device 41 retains its hold on one of the first pair of side wall portions 21 at this point.

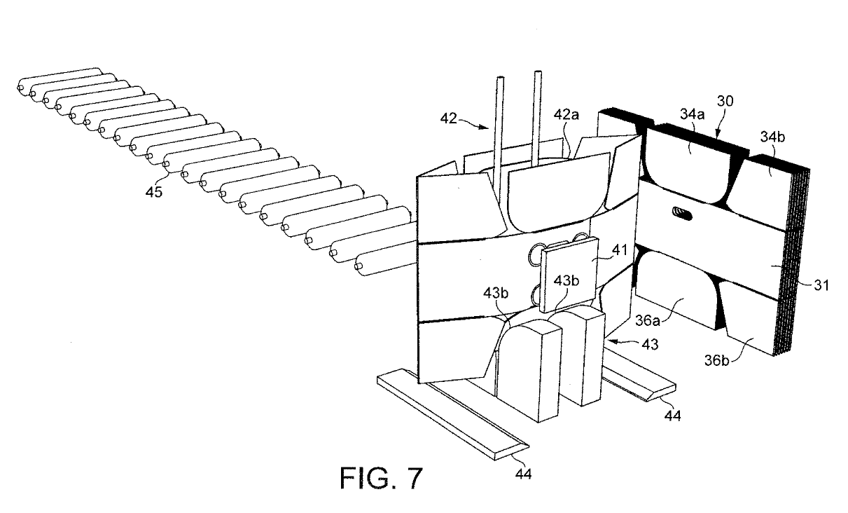

From this position, the insert portion 42 of the separation device is inserted between the first pair of side wall portions in a downward direction, to achieve the configuration shown in FIG. 7. As the edge portion 42b of the insert portion 42 progresses between the first pair of side wall portions, the insert portion 42 also translates away from the suction device 41 in the direction normal to the front surface portion 41a, a machine direction. At the same time, the suction device moves in an opposite direction away from the insert portion, while the flap guides 43 remain stationary relative to the tube 30. The result is that the first pair of side wall portions are gradually pulled apart and the folded second pair of side wall portions unfold to a parallel configuration. However, since no folds are present in the connecting wall portions, these portions smoothly bend to form the rounded corner portions of box 10. At the same time, as the first pair of side wall portions 31 relatively translate apart, urged by the front surface 42a of the insertion portion 42 and the suction device 41 relatively moving in opposite directions, the curved surfaces 43b of the flap guides 43 guide the base wall portions 36a to lie in the same plane, defining a first layer of the base wall 16 of box 10.

Notably, in the present implementation, the rounded corners of the base wall portions 36a act as a template around which the top and base ends of connecting wall portions 33 bend to form a smooth curve. At the same time, the shovel-shaped configuration of insert portion 42, and especially curved surfaces 42c and 42d, provide a template around which the intermediate portions of connecting wall portions 33 curve.

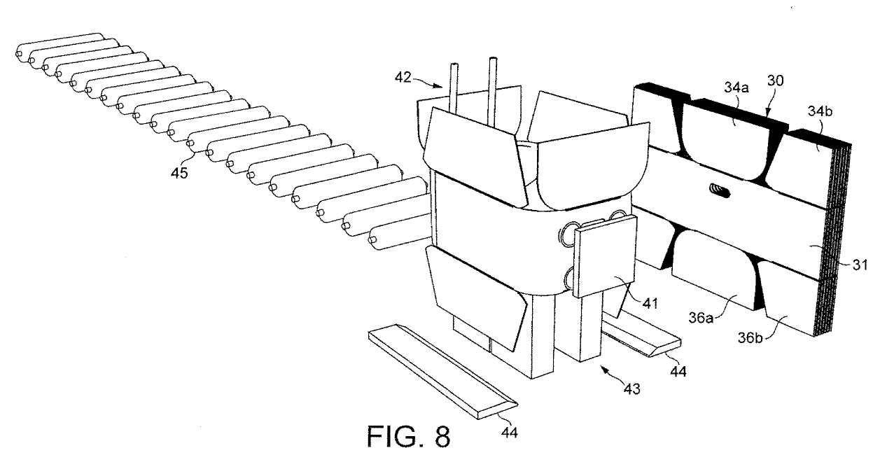

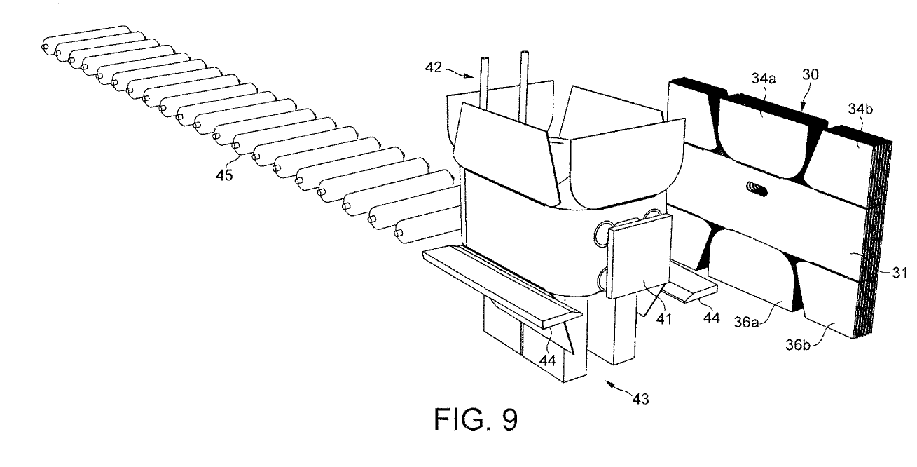

The configuration achieved by this process is shown in FIG. 8, in which the smoothly curved connecting wall portions can be clearly seen. From this position, the flap closing rails 44 are raised to the level of the base surface 16 of the box 10, and then are relatively translated together, as shown in FIG. 9, so as to fold base surface portions 24b inwardly, thereby forming the base surface 16 of the box in full or partial double-layer thickness. At this stage, tape, adhesive or stapling, for example, may be used to secure the base wall portions 26a and 26b in position to form a stable and secure base for the box.

From this position, the suction device 41 can transfer the box 10 having the closed base sides 16 to conveyor 45 for onward handling. The top wall 14 of the box 10 remains open at this point, to allow the box to be filled. The box may then be closed by further closing rails which cooperate to fold top surfaces 24a and 24b inwardly to enclose the void.

However, aside from this implementation, a variety of alternative approaches are possible to the forming of box 10. For example, if the material from which the connecting wall portions are made is sufficiently capable of forming the curved structure unsupported, the forming device can be provided having an insert portion 42 without the curved surface portions 42c and 42d, or alternatively two suction devices 41 or equivalent means can be used to relatively translate apart the first pair of side wall portions.

Also, although the flap guides 43 are provided to allow a convenient way of forming the base of the box, the base of the box can also be formed by closing the flaps individually or in pairs by cooperating flap closing rails after the first pair of side wall portions have been translated apart to form the side wall perimeter of the box.

Alternatively, two insert portions 42 may be provided above and below the box, and then the box can be pulled apart by cooperation of these insert portions respectively inserting towards each other and translating apart from each other, such that each of the first pair of side wall portions is contacted on an inner side by a front surface portion 42a of an insert portion 42, and all of the connecting wall portions are formed around curved surface portions 42c and 42d of the respective insert portions.

Further, although in the sequence described in FIGS. 4 to 10 the flap guides 43 remain static while the insert portion 42a and the suction device 41 respectively move in a machine direction and in a direction opposed to the machine direction to separate the first pair of side wall portions, one or other of the insert portion 42 and the suction device 41 may remain static in the machine direction, and the other may move, as well as the flap guides, away from it.

The process has been described for a box having both a top wall portion and a base wall portion. However, either or both may, as has been described, be omitted so that either an open-top, open-base box or a box sleeve is formed. In such a case, a further stage of providing a separate base or top, such as a formed base insert and a formed lid insert, may be provided as known in the art. Hence, the erecting process may in such a way be applied to tray applications.

Finally, it is notable that in the sequence described in FIGS. 4 to 10, the first pair of side wall portions are pulled apart such that the second pair of side wall portions become planar, i.e., the fold lines completely unfold, however this is not essential. In some configurations, providing an angled side of the box may be desired, and by providing divided base and top surface portions having a cut along the fold line, an alternative configuration wherein the side walls are not completely unfolded may be achieved. In such a case, appropriately-shaped top wall portions or inserts and appropriately-shaped base wall portions or inserts may be required to achieve a stable, enclosed box.

Also with reference to the variant configurations shown in FIGS. 11 to 16, the disclosed blanks, tubes, methods and apparatuses can be straightforwardly adapted without undue effort or experimentation to apply to a variety of boxes having desirable configurations. In light of the foregoing disclosure, there will also be many alternatives which implement the teaching of the present disclosure. It is expected that one skilled in the art will therefore be able to modify and adapt the above disclosure to suit his own circumstances and requirements within the scope of the present invention, while retaining some or all technical effects of the same, either disclosed or derivable from the above, in the light of his common general knowledge of the art. All such equivalents, modifications or adaptions fall within the scope of the invention hereby defined and claimed.

1. A packaging box comprising:
a perimeter wall defining a void therein,
wherein the perimeter wall includes a first fold line and a second fold line,
wherein the first fold line and the second fold line are parallel,
wherein a distance around the perimeter wall from the first fold line to the second fold line measured in a first plane perpendicular to the first and second fold lines in a first rotational sense is the same as a distance around the perimeter wall from the first fold line to the second fold line in the first plane in a second rotational sense opposite to the first rotational sense, and
wherein the first fold line is fully unfolded such that the perimeter wall has a continuous surface including the first fold line.

2. The packaging box according to claim 1, wherein the second fold line is fully unfolded such that the perimeter wall has a continuous surface including the second fold line.

3. The packaging box according to claim 1, further comprising an internal wall portion arranged at an angle to the perimeter wall and contacting an internal surface of the perimeter wall so as to support the perimeter wall against an external compressive force directed toward the void.

4. The packaging box according to claim 3, wherein the internal wall portion is a base wall portion arranged in a plane.

5. The packaging box according to claim 4, wherein the internal wall portion is arranged in the first plane.

6. The packaging box according to claim 1, wherein the perimeter wall has at least a first curved portion that is smoothly curved in the first plane so as to include no fold line.

7. The packaging box according to claim 6, wherein the box has a plane of symmetry with respect to the shape of the perimeter wall within the first plane, the perimeter wall having a first end portion and a second end portion arranged at opposite positions, each portion including a respective one of first and second intersection positions with the plane of symmetry, at least one of the first and second end portions including the curved portion.

8. The packaging box according to claim 7, wherein the first end portion comprises a pair of first curved portions of the perimeter wall, each portion of the pair of first curved portions respectively extending in opposite senses from the first intersection position with the plane of symmetry toward a respective one of the first fold line and the second fold line.

9. The packaging box according to claim 8, wherein the first end portion includes a first planar portion of the perimeter wall including the first intersection position with the plane of symmetry arranged directly between the pair of first curved portions.

10. The packaging box according to claim 8, wherein a respective pair of third planar portions directly connects each portion of the pair of first curved portions to the respective one of the first fold line and the second fold line.

11. The packaging box according to claim 8, wherein the second end portion comprises a pair of second curved portions of the perimeter wall, each portion of the pair of second curved portions respectively extending in opposite senses from the second intersection position with the plane of symmetry toward one of the first fold line and the second fold line.

12. The packaging box according to claim 11, wherein the second end portion includes a second planar portion of the perimeter wall including the second intersection position with the plane of symmetry arranged directly between the pair of second curved portions.

13. The packaging box according to claim 11, wherein a respective pair of third planar portions directly connects each portion of the pair of first curved portions to the respective one of the first fold line and the second fold line, and wherein a respective pair of fourth planar portions directly connects each portion of the pair of second curved portions to the respective one of the first fold line and the second fold line.

14. The packaging box according to claim 13, wherein the fourth planar portions are coplanar with the third planar portions across each fold line of the first fold line and the second fold line.

15. The packaging box according to claim 14, wherein the fourth planar portions are parallel to the third planar portions.

16. The packaging box according to claim 1, wherein the first fold line and the second fold line are positioned in the perimeter wall such that a distance across the void between the first fold line and the second fold line is a minimum distance with respect to position of the first fold line and the second fold line in the perimeter wall.

17. A tube for forming a packaging box, comprising:
a perimeter wall having a first layer and a second layer being mutually parallel and arranged for defining a void therebetween,
wherein the perimeter wall is provided with a first fold line and a second fold line, the first and second fold lines connecting the first layer to the second layer at opposite ends of the first layer and the second layer,
wherein the first fold line and the second fold line are mutually parallel,
wherein a distance around the perimeter wall from the first fold line to the second fold line measured in a first plane perpendicular to the first and second fold lines in a first rotational sense is the same as a distance around the perimeter wall from the first fold line to the second fold line in the first plane in a second rotational sense, the perimeter wall being configured such that when the first layer and the second layer are relatively translated away from each other, the first fold line can be fully unfolded such that the perimeter wall has a continuous surface including the first fold line.

18. A contiguous blank for forming a packaging box, comprising:
a contiguous portion for defining the perimeter wall of the packaging box, the contiguous portion having a first portion and a second portion,
wherein the contiguous portion is provided with a first fold line connecting the first portion to the second portion at a first end of the first portion and a first end of the second portion and a second fold line connecting the first portion to a tab portion at the another end of the first portion,
wherein the first fold line and the second fold line are mutually parallel, and are both mutually parallel to another end of the first portion, and
wherein a distance along the contiguous portion from the first fold line to the second fold line measured in a first direction perpendicular to the first and second fold lines is the same as a distance from the first fold line to the second end of the first portion.

19. An apparatus for forming a folded tube according to claim 17 into a packaging box, the apparatus comprising:
a handling means for transporting the folded tube to a first position at a forming station in which the folded tube in a flat state is arranged perpendicular to a machine direction, the handling means having a gripping means for gripping a planar portion of the peripheral wall; and
a forming means having an insert portion for insertion in a first direction perpendicular to the machine direction between the one and the other of the first and second layers at the forming station,
wherein the insert portion has a front surface portion facing the machine direction for contacting a first one of the first and second layers; an insertion-direction edge in the insertion direction; and a pair of curved surface portions extending outwardly in a second direction perpendicular to the machine direction and the first direction from opposite sides of the front surface portion and curving away from the front surface portion in a direction opposite to the machine direction, the pair of curved surface portions tapering from the front surface portion such that the insertion-direction edges of the curved surface portions progress further in a direction opposite to the insertion direction of the insertion-direction edge of the front surface portion with distance away from the front surface portion in the second direction, and
wherein the insertion means and the gripping means are relatively movable towards each other in the insertion direction and are relatively movable in the machine direction away from each other.

20. A method of forming a tube according to claim 17 into a packaging box, the method comprising:
providing the tube in a folded configuration in which the first layer and the second layer are approximated such that the fold lines are fully folded; and
translating one of the layers apart from the other of the layers such that the fold lines each become relatively less folded, thereby to form the box.

21-60. (canceled)
